(19) United States
(12) Patent Application Publication
(10) Pub. No.: US 2014/0213197 A1
(43) Pub. Date: Jul. 31, 2014

(54) SIGNAL DETECTION USING A WIDE/NARROW-BAND RF TRANSCEIVER

(71) Applicants: Wei An, Newton, MA (US); Yosef Stein, Sharon, MA (US)

(72) Inventors: Wei An, Newton, MA (US); Yosef Stein, Sharon, MA (US)

(21) Appl. No.: 13/755,942

(22) Filed: Jan. 31, 2013

(51) Int. Cl. H04B 1/40

(52) U.S. Cl. CPC H04B 1/40
USPC 455/73; 455/266; 455/232.1

(57) ABSTRACT

A wide/narrow-band RF transceiver receives a signal in wide-band RF spectrum; a processor analyzes the signal and narrows the bandwidth of the RF transceiver in accordance with a carrier frequency, bandwidth, and RF modulation type of the signal.

### TECHNICAL FIELD

Embodiments of the current invention related to RF transceivers and, more particularly, to configuring RF transceivers for use with different modulation schemes.

### BACKGROUND

An RF transceiver may be designed to be compatible with a variety of different signal-modulation schemes, each having a different channel spectrum and bandwidth. The IEEE 802.15.4g standard, for example, employs several different modulation schemes, and an RF transceiver that communicates in accordance with the standard must accommodate them all. FIG. 1 illustrates several modulation schemes used in an illustrative 26 MHz frequency slice or “bandwidth” (ranging from, in this example, 902 MHz-928 MHz), including frequency-shift keying (“FSK”), offset quadrature-phase-shift keying (“O_QPSK”), and orthogonal frequency-domain multiplexing (“OFDM”). A so-called “wideband” RF transceiver is capable of monitoring this entire bandwidth, but is usually configured to “zoom into” a particular subset of it in accordance with the currently selected modulation scheme. This configuration allows the RF transceiver to receive and sample the incoming signal with greater resolution and accuracy; the RF transceiver may later “zoom out” to detect a different modulation scheme or a different bandwidth slice of the current scheme.

The RF transceiver is a low-level hardware device; its specific configuration is largely determined, in existing systems, at a higher level (using, e.g., firmware/software-based control and analysis mechanisms). In the seven-layer open-systems interconnection (“OSI”) model, the RF transceiver itself exists at layer one (the “physical” or “PHY” layer) and it is configured at layer two (the “data link” layer) or, more specifically, at the media-access control (“MAC”) subset of layer two. The RF transceiver monitors the broader spectrum and passes information up to the MAC layer, which analyzes the data to determine, for example, where in the broader spectrum an incoming signal lies and how it is modulated, and configures the RF transceiver appropriately. The performance of these functions at the higher level, however, may slow down the configuration time of the RF transceiver (causing the loss of data), consume more power, or both. A need therefore exists for low-level configuration of the RF transceiver.

### SUMMARY

In general, various aspects of the systems and methods described herein control a wide/narrow-band RF transceiver at a hardware level (e.g., at OSI level two) to transmit and receive RF signals encoded in a variety of different modulation schemes and at different carrier frequencies and bandwidths. A signal is detected using an RF transceiver configured to receive a wide-bandwidth signal and the detected signal is analyzed—e.g., in a digital-signal processor (“DSP”). Based on the results of the analysis (such as estimation of the carrier frequency and the signal bandwidth), the RF transceiver bandwidth is narrowed so that it will receive a desired signal detected in the wide-bandwidth signal but not unnecessary frequencies. In one embodiment, the DSP also classifies the type of modulation used. Embodiments of the invention may be performed wholly or mostly in the OSI physical layer, requiring little or no support from the OSI data-link layer, and thereby reducing power consumption and the number of missing data frames. Although the ensuing discussion focuses on the OSI scheme, embodiments of the invention may be situated within analogous levels of any protocol stack or set of abstraction layers.

In one aspect, a method for adjusting a bandwidth of a receiver detecting an RF signal includes listening to a wide bandwidth of RF frequencies, the bandwidth being divided into a plurality of power-spectrum bins, detecting which of the plurality of power-spectrum bins are active, estimating a carrier frequency and bandwidth of the signal based on the detected active power-spectrum bins, and narrowing the bandwidth of the receiver in accordance with the estimated frequency and bandwidth.

A modulation scheme used for the signal may be classified. A gain of the receiver may be increased (by, e.g., enabling a maximum gain of the receiver) during listening and reduced during detecting (by, e.g., setting the gain to a value less than the maximum gain). Similarly, a sampling rate of the receiver may be decreased during listening and increased during detecting. Estimating the frequency and bandwidth may include performing an FFT of the wide bandwidth of RF frequencies and/or further include performing a power spectrum operation on a result of the FFT. Detecting which power-spectrum bins are active may include comparing a power level of the power-spectrum bins to a threshold. Estimating the bandwidth of the signal may include multiplying a bandwidth of each active power-spectrum bin by a number of consecutive active power-spectrum bins and may further include ignoring consecutive active power-spectrum bins outside of an expected bandwidth. Detecting the signal may include performing an RSSI operation on the wide bandwidth of RF frequencies.

In another aspect, a system for detecting an RF signal includes an RF transceiver (having a wide-bandwidth mode and a narrow-bandwidth mode) for receiving an RF signal. The RF transceiver includes a controller for (i) operating the RF transceiver in the wide-bandwidth mode to detect a signal in the wide bandwidth, (ii) estimating a carrier frequency and bandwidth of the signal, and (iii) operating the RF transceiver in the narrow-bandwidth mode to receive a narrow bandwidth determined in accordance with the estimated frequency and bandwidth.

The processor may be a digital-signal processor; an RF antenna may be in electrical communication with the RF transceiver, and a data-link layer device may be in communication with the processor. The RF signal may be sampled at a lower frequency during the wide-bandwidth mode and at a higher frequency during the narrow-bandwidth mode. The lower frequency may be 13 MHz and the higher frequency may be 26 MHz. The RF transceiver may be configured to divide the RF signal into a plurality of power-spectrum bins. The carrier frequency may be estimated based on a center of the power-spectrum bins receiving a signal, and the bandwidth may be estimated based on a number of consecutive active power-spectrum bins receiving a signal. Estimating the bandwidth of the signal may further include ignoring consecutive active power-spectrum bins outside of an expected bandwidth.

In another aspect, a digital-signal processor includes an RF transceiver (having a wide-bandwidth mode and a narrow-bandwidth mode) for receiving an RF signal and a digital-signal processor core for (i) operating the RF transceiver in the wide-bandwidth mode to detect a signal in the wide bandwidth, (ii) estimating a carrier frequency and bandwidth of the signal, and (iii) operating the RF transceiver in the narrow-bandwidth mode to receive a narrow bandwidth determined in accordance with the estimated frequency and bandwidth. An input/output port may communicate with a data-link layer device.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology. The term “substantially” or “approximately” means ±10% (e.g., by weight or by volume), and in some embodiments, ±5%.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 illustrates different modulation schemes in an exemplary frequency band;

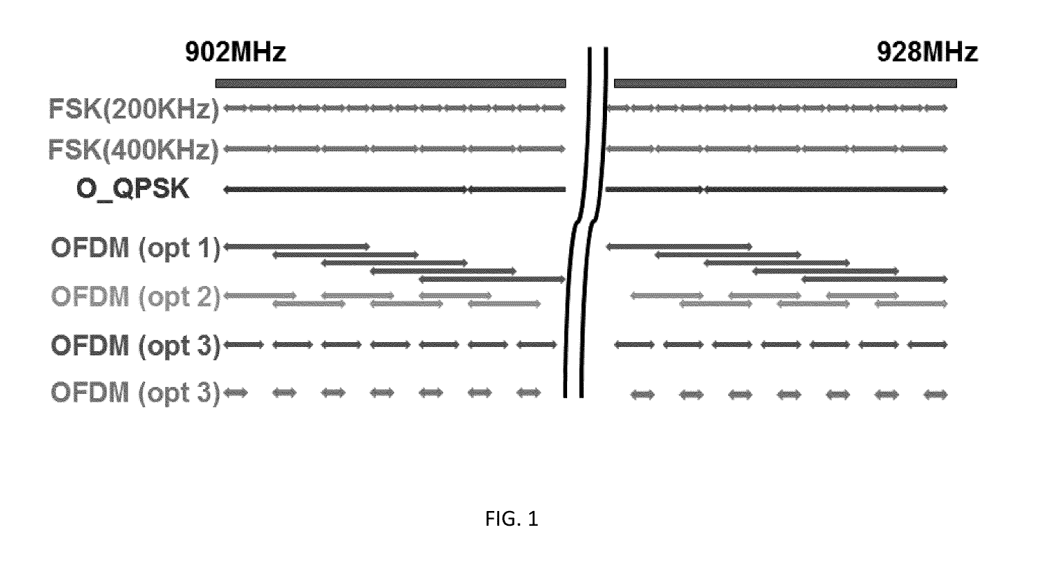

FIG. 2 is a block diagram of a system for detecting a signal using a wide/narrow-band RF transceiver in accordance with an embodiment of the invention;

FIG. 3 is a flowchart of a method for detecting a signal using a wide/narrow-band RF transceiver in accordance with an embodiment of the invention;

FIG. 4 is a graph of a wide-band frequency spectrum in accordance with an embodiment of the invention;

FIG. 5 is a graph of a wide-band frequency spectrum that includes a received signal in accordance with an embodiment of the invention;

FIG. 6 is a graph of a wide-band frequency spectrum that includes power-saving techniques in accordance with an embodiment of the invention; and

FIG. 7 is a graph of a narrowed frequency spectrum that includes the received signal in accordance with an embodiment of the invention.

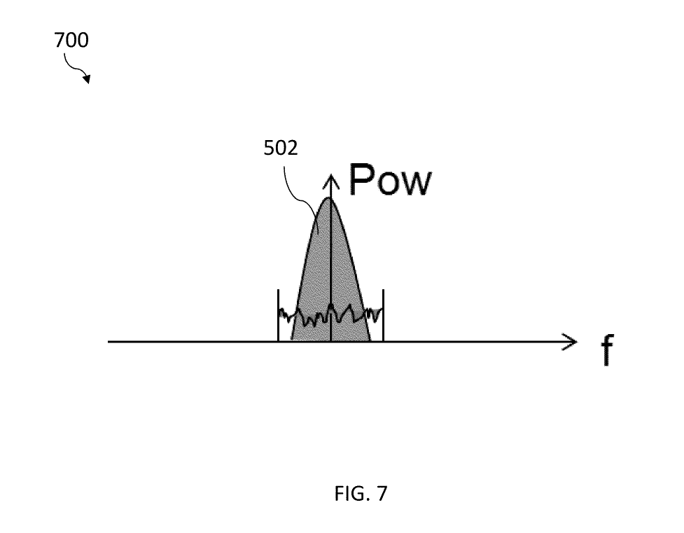

### DETAILED DESCRIPTION

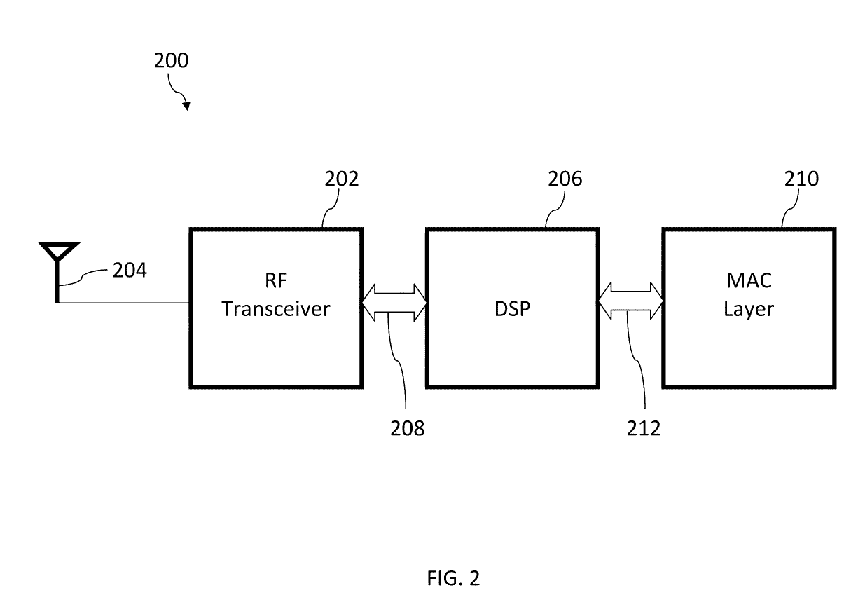

A system 200 for hardware-level control (i.e., OSI level-one or “physical layer” control) of a wide/narrow-band RF transceiver 202 is illustrated in FIG. 2. Signals are received and broadcast via an antenna 204 electrically connected to the RF transceiver 202. A digital-signal processor (“DSP”) 206 communicates with the transceiver 202 via a communications link 208, which may be used for sending and receiving data and/or control signals. The DSP 206, in turn, communicates with a higher-level (e.g., OSI level two or greater) MAC device or system 210 via another communications link 212. The RF transceiver 202 may be any device capable of adjusting its active bandwidth and carrier frequency in response to control/command signals and, in particular, capable of supporting a first, wider bandwidth and additional, narrower bandwidths disposed within the original wide bandwidth. The DSP 206 may be any processor capable of performing signal-processing tasks (such as, for example, fast Fourier transforms). The system as depicted in FIG. 2 shows one RF transceiver 202 and one DSP 206, but the DSP 206 may be used to support multiple RF transceivers 202. The MAC device 210 may be any appropriate system, interface, processor, or other network-based station or node; the current invention is not limited to any particular MAC device 210. The three pictured components 202, 206, 210 may be combined or further separated, as one of skill in the art will understand.

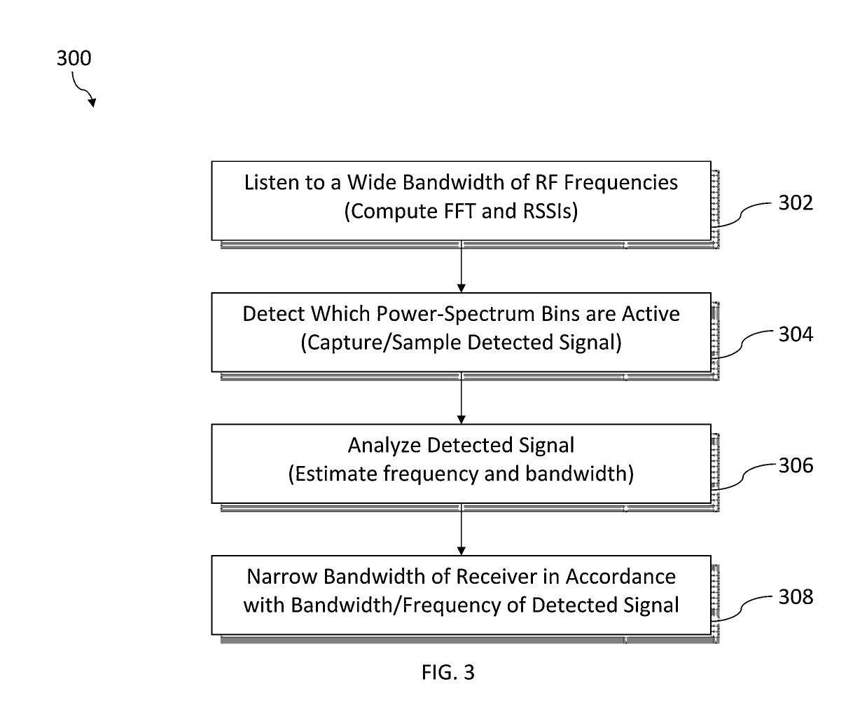

A method 300 for using the system 200 is illustrated in FIG. 3. In a first step 302, the RF transceiver 202 listens to (i.e., receives and processes) a wide bandwidth of RF frequencies (e.g., frequencies ranging from 902 MHz-928 MHz). The term “wide,” as used herein to refer to a bandwidth, means any bandwidth spectrum that may contain a plurality of signals/symbols having different frequencies; the spectrum may thus be narrowed to view a subset (e.g., one) of the frequencies. The RF transceiver 202 may be configured to have maximum gain (i.e., its automatic gain-control function may be disabled). Signals may appear anywhere within the bandwidth and may be encoded in any of a number of different modulation schemes (e.g., FSK, O_QPSK, or OFDM). The RF transceiver 202 may be recently powered on, waking up from a sleep mode, or have been otherwise dormant for a period of time prior to the listening window, and may thus not be aware of which modulation scheme will next be used to receive data. Alternatively, an earlier transmission may have simply ended and the transceiver 202 may not know the type of a next transmission. In any event, the transceiver 202 samples the transmission received by the antenna 204 and sends it to the DSP 206. In one embodiment, the transceiver 202 uses a sampling rate approximately equal to the size of the monitored bandwidth window (e.g., a 26 MHz sample rate for a 26 MHz window). In other embodiments, the sampling rate may be less than the size of the bandwidth window; for example, the sampling rate may be one-half the size of the window (e.g., a 13 MHz sample rate for a 26 MHz window).

The DSP 206 performs a fast Fourier transform (“FFT”) on the sampled data. The number of points in the FFT may be selected in accordance with the minimum channel spacing of the received transmission such that each channel intersects with at least one FFT point. For example, if each of the carriers within the bandwidth spectrum are at least 200 kHz in size, 128 FFT points may be taken (i.e., distributed evenly across the bandwidth spectrum) to ensure that none of the carriers are missed (because 26 MHz÷200 kHz≈128 points).

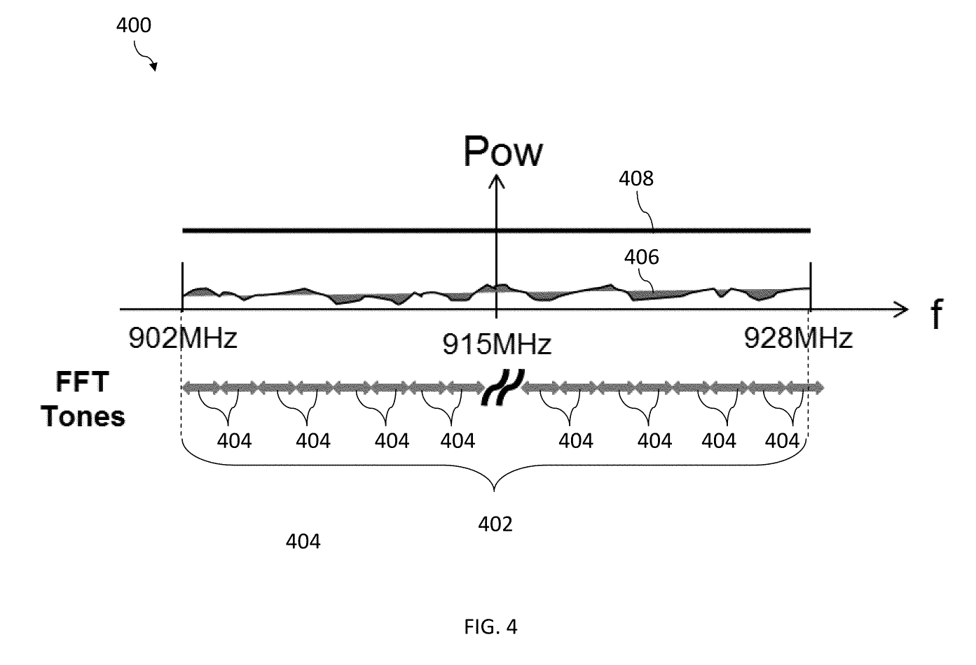

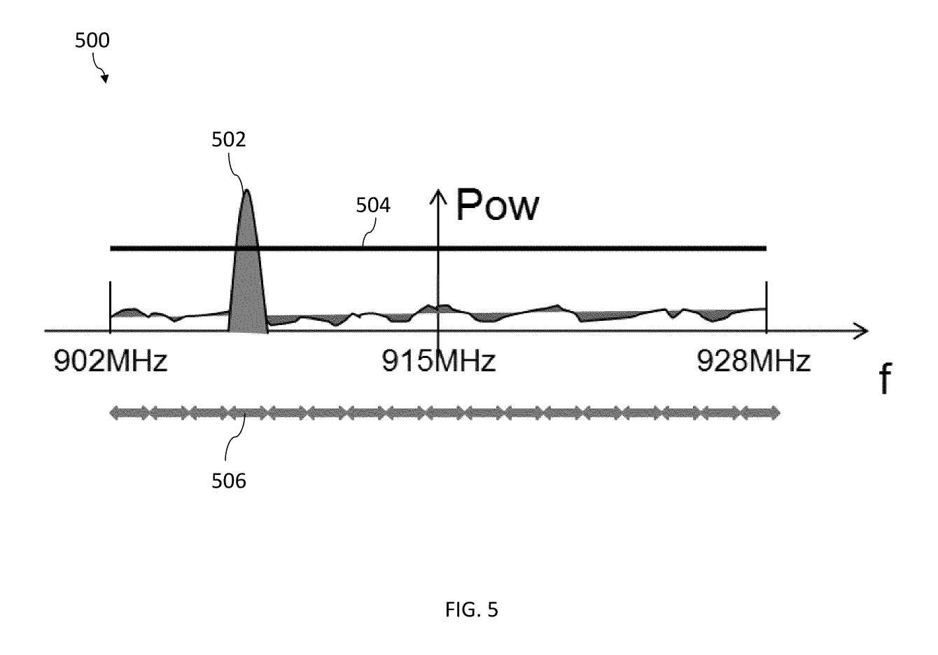

Operation of the FFT is illustrated at 400 in FIG. 4. The representative bandwidth spectrum 402 (from 902 MHz to 928 MHz) is shown with its carrier frequency, 915 MHz, in its center. The FFT points correspond to bins or “buckets” 404 that span the width of the spectrum 402. Each bin 404 (also known as atone) corresponds to range of frequencies and has a power-spectrum level corresponding to the power level of signal(s) that may be received in that range of frequencies. A bin 404 may be considered “active” if the power level of the signals received therein is greater than a threshold (as explained in greater detail below with reference to FIG. 5). The size of each bin 404 may be equal to the sampling rate divided by the FFT size; the power spectrum of the bandwidth spectrum 402 may thus be computed as √(Re(FFT)²+Im(FFT)²). In one embodiment, a received-signal strength indication (“RSSI”) is performed on each bin 404 to create a value representative of the power received within the frequency span represented by each bin 404. The FFT and the RSSI are applied to an incoming signal, which in this case contains only noise 406, and the results are applied to a threshold 408. Because, in this case, the noise 406 contains no components that cross the threshold 408, the method 300 does not proceed beyond step 302 at this point and merely continues to listen to the noise 406.

Operation at step 302 is further illustrated in FIG. 5, which shows a frequency spectrum 500 that includes a signal component 502 whose power exceeds a threshold 504 for one FFT bucket 506. In one embodiment, the component 502 is captured and/or sampled when its power level crosses the threshold 504. The threshold 504 may be a fixed value set in accordance with minimum signal-power levels (as specified by, for example, the IEEE 802.15.4g standard) or may be determined by expected signal and noise power levels. In one embodiment, the threshold 504 is twice the value of a maximum noise level. The threshold 504 may also be set by a programmable register, memory, fuse, or other such control mechanism to account for, e.g., different applications, standards, or modulation schemes. The threshold 504 may further be configured dynamically, instead of or in conjunction with other control mechanisms, to account for varying signal and/or noise levels. For example, if a power level of the noise increases, the threshold 504 may be raised in response to prevent erroneous detection of a signal.

In another embodiment, the length of time that the power level of the component 502 is above the threshold 504 is first evaluated, and the component 502 is not captured/sampled until this length of time exceeds a certain amount. This requirement that the power level of the component 502 persists above the threshold 504 for a certain minimum amount of time may prevent short-duration, transitory noise spikes from producing errors. The length of time may be, for example, 0.1, 0.5, 1, or 5 nanoseconds and may be (like the threshold 504) adjustable or dynamically adaptable.

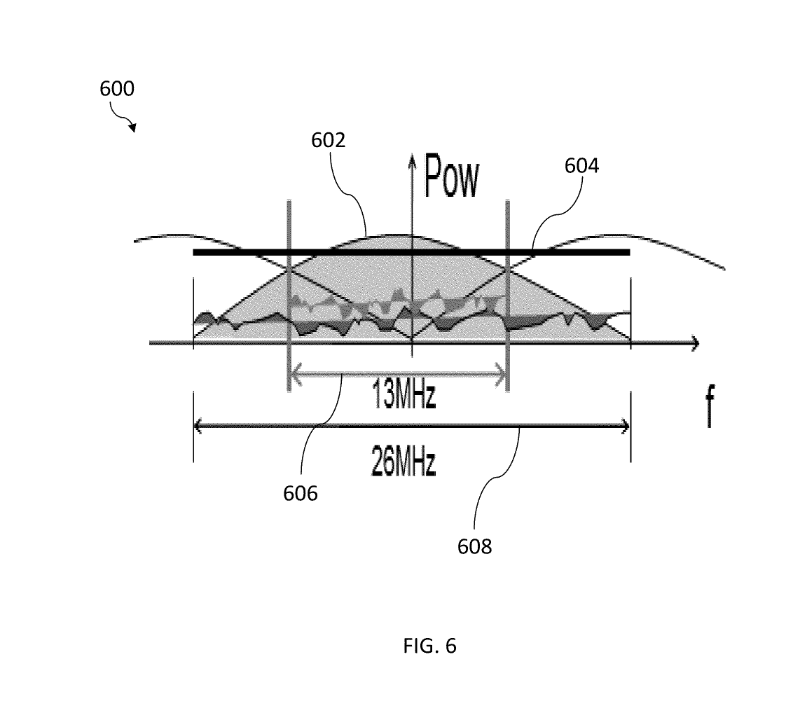

In an alternative embodiment, instead of or in addition to the performance of the FFT and RSSI by the DSP 206, the RF transceiver 202 performs an RSSI operation (or other measurement of signal power) on the incoming signal. FIG. 6 illustrates a frequency spectrum 600 that includes an RSSI power level 602 increasing past a threshold 604 (and thus indicates arrival of a signal). Because the RF transceiver 202 does not perform an FFT, its RSSI computation encompasses the entire spectrum (not individual FFT buckets) and thus may have lower sensitivity and/or increased susceptibility to noise. Performance of the RSSI in the RF transceiver 202, however, reduces power consumed by the DSP 206 and may lower overall power consumption of the system 200.

In another, similar embodiment, with continued reference to FIG. 6, the RF transceiver 202 reduces its listening window during the listening period (and widens it during the capture period, as described in greater detail below). For example, the listening window 606 may be reduced to 13 MHz during listening and widened to a 26 MHz sampling window 608 during sampling. This lower sampling rate for listening may reduce the frequency required for any analog-to-digital converters used for analyzing the incoming signal and/or lower the sample rate required for the RSSI computation, thereby reducing the power consumed by both the RF transceiver 202 and the DSP 206. While the lower sample rate may lead to aliasing in the signal, because the system is analyzing only the power of the signal, the potential aliasing may not affect the power measurement.

Once a signal is detected, in a second step 304, the signal (or signals) is sampled and/or captured over a given period of time. In one embodiment, the signal is captured during some or all of the listening step 302 and, once one or more portions of the signal (e.g., different power-spectrum bins of the signal) is determined to have passed the power and/or time threshold, the already-captured signal is analyzed. In other embodiments, capture begins only after the power and/or time thresholds have been met or continues after the power and/or time thresholds have been met. Once the signal is captured, the RF transceiver may switch on automatic-gain control (or otherwise reduce the gain from a max gain).

The DSP 206 analyzes the captured spectrum in a third step 306. For each group of active tones in the spectrum, the DSP 206 calculates the center and bandwidth. The center of each group of active tones corresponds to the carrier frequency of that group, and the number of each group of active tones corresponds to the bandwidth of that group. For example, if five adjacent tones are active (i.e., if the signal level in five adjacent FFT bins is above a threshold level), the carrier frequency may be estimated to correspond to the frequency of the third (or center) tone or bin. The bandwidth of the group may be determined by the number of active tones (here, five) multiplied by the bandwidth of each tone (e.g., 1 MHz). The DSP 206 may thus estimate the carrier frequency and signal bandwidth for any number of groups and/or tones within the groups. In one embodiment, a certain number of groups and/or tones within each group are expected (for, e.g., known modulation types such as FSK, O-QPSK, or OFDM); any detected groups having a different number of tones are ignored. If multiple groups are present, each group may be analyzed in turn based on, for example, the signal or power strength of each bin (from highest to lowest). If the DSP 206 is capable of it, more than one group may be analyzed at once.

In a fourth step 308, the RF transceiver 202 is reconfigured in accordance with the estimated carrier frequency and bandwidth to “zoom in” on the active tone(s). For example, with reference again to FIG. 5, the initial bandwidth of the RF transceiver 202 (i.e., 902 MHz-928 MHz) may be changed to focus on the bandwidth of the detected signal 502 (approximately 907 MHz-909 MHz). The new carrier frequency in this example is 908 MHz. A depiction 600 of the result of reconfiguring the RF transceiver 202 to focus on the signal 502 is shown in FIG. 6.

The RF transceiver 202 may be further configured to change its sampling rate. For example, the sampling rate may be decreased to reflect the now-smaller part of the full spectrum under consideration (to thereby save on power and processing time in collecting and analyzing the samples) or, in another embodiment or under different operating conditions, increased to increase the accuracy of the collected samples.

The DSP 206 may further analyze the sampled data (either the previously collected data or new data collected after the RF transceiver has been narrowed to focus on the detected signals) to classify the modulation scheme employed by the incoming signal. In one embodiment, the DSP 206 compares the carrier frequency and signal bandwidth to known values of carrier frequencies and signal bandwidths (stored in, for example, a look-up table) and selects a matching modulation scheme. The DSP 206 may further analyze additional properties of the incoming signal, such as its peak-to-average (“PAR”) ratio and its preamble, to confirm or adjust its earlier classification. Once the modulation scheme is classified, the DSP 206 may pass this information to the MAC layer 210 so that it may begin decoding the information contained in the signal in accordance with the modulation scheme.

Certain embodiments of the present invention have described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for adjusting a bandwidth of a receiver detecting an RF signal, the method comprising:
listening to a wide bandwidth of RF frequencies, the bandwidth being divided into a plurality of power-spectrum bins;
detecting which of the plurality of power-spectrum bins are active;
estimating a carrier frequency and bandwidth of the signal based on the detected active power-spectrum bins; and
narrowing the bandwidth of the receiver in accordance with the estimated frequency and bandwidth.

2. The method of claim 1, further comprising classifying a modulation scheme used for the signal.

3. The method of claim 1, further comprising increasing a gain of the receiver during listening and reducing the gain of the receiver during detecting.

4. The method of claim 3, wherein increasing the gain comprises enabling a maximum gain of the receiver and wherein reducing the gain comprises setting the gain to a value less than the maximum gain.

5. The method of claim 1, further comprising decreasing a sampling rate of the receiver during listening and increasing the sampling rate of the receiver during detecting.

6. The method of claim 1, wherein estimating the frequency and bandwidth comprises performing an FFT of the wide bandwidth of RF frequencies.

7. The method of claim 6, wherein estimating the frequency and bandwidth further comprises performing a power spectrum operation on a result of the FFT.

8. The method of claim 7, wherein detecting which power-spectrum bins are active comprises comparing a power level of the power-spectrum bins to a threshold.

9. The method of claim 8, wherein estimating the bandwidth of the signal comprises multiplying a bandwidth of each active power-spectrum bin by a number of consecutive active power-spectrum bins.

10. The method of claim 9, wherein estimating the bandwidth of the signal further comprises ignoring consecutive active power-spectrum bins outside of an expected bandwidth.

11. The method of claim 1, wherein detecting the signal comprises performing an RSSI operation on the wide bandwidth of RF frequencies.

12. A system for detecting an RF signal, the system comprising:
an RF transceiver for receiving an RF signal, the RF transceiver having a wide-bandwidth mode and a narrow-bandwidth mode;
a controller for (i) operating the RF transceiver in the wide-bandwidth mode to detect a signal in the wide bandwidth, (ii) estimating a carrier frequency and bandwidth of the signal, and (iii) operating the RF transceiver in the narrow-bandwidth mode to receive a narrow bandwidth determined in accordance with the estimated frequency and bandwidth.

13. The system of claim 12, wherein the processor is a digital-signal processor.

14. The system of claim 12, further comprising an RF antenna in electrical communication with the RF transceiver.

15. The system of claim 12, further comprising a data-link layer device in communication with the processor.

16. The system of claim 12, wherein the RF signal is sampled at a lower frequency during the wide-bandwidth mode and at a higher frequency during the narrow-bandwidth mode.

17. The system of claim 16, wherein the lower frequency is 13 MHz and the higher frequency is 26 MHz.

18. The system of claim 12, wherein the RF transceiver is configured to divide the RF signal into a plurality of power-spectrum bins.

19. The system of claim 18, the carrier frequency is estimated based on a center of the power-spectrum bins receiving a signal, and the bandwidth is estimated based on a number of consecutive active power-spectrum bins receiving a signal.

20. The system of claim 19, wherein estimating the bandwidth of the signal further comprises ignoring consecutive active power-spectrum bins outside of an expected bandwidth.

21. The system of claim 19, where an active power-spectrum bin is a power-spectrum bin having a magnitude above a predefined threshold

22. A digital-signal processor comprising:
an RF transceiver for receiving an RF signal, the RF transceiver having a wide-bandwidth mode and a narrow-bandwidth mode;
a digital-signal processor core for (i) operating the RF transceiver in the wide-bandwidth mode to detect a signal in the wide bandwidth, (ii) estimating a carrier frequency and bandwidth of the signal, and (iii) operating the RF transceiver in the narrow-bandwidth mode to receive a narrow bandwidth determined in accordance with the estimated frequency and bandwidth.

23. The digital-signal processor of claim 22, further comprising an input/output port for communicating with a data-link layer device.
